(19) United States
(12) Patent Application Publication
(10) Pub. No.: US 2007/0112689 A1
(43) Pub. Date: May 17, 2007

(54) System for media integration

(76) Inventor: Charles D. Brown, Woodinville, WA (US)

Correspondence Address: Patrick M. Dwyer PC, 14419 Greenwood Ave. N, #322, Seattle, WA, 98133-6865, US

(21) Appl. No.: 11/595,794

(22) Filed: Nov. 11, 2006

Related U.S. Application Data
(63) Continuation-in-part of application No. 10/993,921, filed on Nov. 19, 2004.
(60) Provisional application No. 60/524,295, filed on Nov. 21, 2003.

(51) Int. Cl. G06Q 99/00; G06Q 30/00

(52) U.S. Cl. 705/80; 705/1; 705/14

(57) ABSTRACT

A system is disclosed to serve marketing, sales and promotional needs of community event promoters and sponsors, particularly community events such as festivals and fairs. The system integrates radio advertising, television advertising, an Internet website, electronic messaging, in-person interaction, a chamber of commerce tour and specially filmed media presentations, providing a many faceted environment of multimedia and in-person impressions. The website offers contest participation, search capabilities for the location of events, event, sponsor, promoter and performer showcases and a backstage services locator. Plus, elements of the system are implemented before, during and after events to surround the event and its attendees with event advertising and sponsor impressions. The system increases event attendance, creates an advantageous connection of the fun and celebration of a festival or event to sponsors and extends the marketing potential beyond the dates of the event.

This application is a Continuation-in-Part of Ser. No. 10/993,921 filed Nov. 19, 2004, which claims priority to Ser. No. 60/524,295 filed Nov. 21, 2003.

### TECHNICAL FIELD

The invention relates to a system for media integration; more particularly, it relates to a system for integrated, repeat impression, multimedia marketing for events; and further more particularly, it relates to a system for integrated, repeat impression, multimedia marketing for festivals and community events on behalf of one or more event promoters or event sponsors.

### BACKGROUND OF THE INVENTION

Festivals and community events must be promoted in order to attract the maximum number of attendees. In addition, event promoters negotiate sponsorship with sellers of goods and services in return for advertising opportunities unique to the event. Typically, sponsors of the event are named peripherally in the event advertising segments, and a sponsor may choose to develop a marketing campaign around the fact of their sponsorship of the event, but often there is not a carefully planned marketing program developed in concert between the event promoters and the event sponsors. Such sponsor-driven marketing campaigns do not take full advantage of the opportunity to make impressions on consumers afforded by a community event, and the sponsor does the advertising with generally no view to causing attendance at the event.

Even when attendance is an unintentional affect, the campaign is still short range and limited and the event related marketing campaigns of sponsors often end abruptly at the close of the event. This fails to capitalize on any goodwill and momentum built through the sponsor's association with the event.

In addition, since each event often has different promoters by dint of varying geography, theme and demographics, sponsors must work with many separate promoters to develop marketing around the sponsorship of several simultaneous or contiguous events. Currently, some major sponsors connect themselves to separate events (usually closely related event series, such as the Subaru bike races or the Danskin triathlon series.) Generally, however, marketing campaigns are often not integrated between multiple community events. Which events to sponsor are often chosen randomly with no coordination between events for timing, demographics, geography and themes. Conventional sponsor campaigns do not generally direct consumers to a next sponsored event, and, the effectiveness of one event's campaign is not audited, evaluated or used to inform the next sponsored event's marketing program.

To gain the maximum benefit for event promoters and sponsors alike, an integrated marketing process, spanning multiple media and carrying the marketing campaign past the close of the event, is needed. A system or process is needed for coordinating and managing multiple sponsors over multiple event families (within this application sometimes referred to as “communities of events”), not just in-bred series. In addition, a system or process is needed that serves the needs of both event promoters and event sponsors, where the festival ads are geared to causing event attendance and to further developing and connecting attendees with sponsors at the events, and with past and future events in the family.

### DISCLOSURE OF THE INVENTION

The disclosed system is designed to provide such a system to serve marketing, sales and promotional needs of community event promoters and sponsors. The system integrates radio advertising, television advertising, electronic messaging, Internet websites, in-person messaging, small staged events in surrounding communities, contests and specially filmed or digitally recorded productions or shows, thus separately or together, providing a many faceted environment of multimedia and in-person impressions. Plus, elements of the system are implemented before, during and after events to surround the event and its attendees with event advertising and sponsor impressions. Within a single event, the system provides for mutually beneficial integration between event promoters and sponsors by increasing event attendance, taking full advantage of the festival or event environment by connecting the sponsor with the celebration and fun of the event, and extending the marketing potential beyond the end of the event.

The system coordinates and manage multiple sponsors over multiple events related in families of events, also referred to as “communities of events”. The disclosed system is designed to organize networks of sponsorable events and deliver a system of multimedia marketing integrated throughout all events. The festival advertisements are geared to causing event attendance and sponsor connection to the event, advertising with means (hooks) to further develop and connect attendees with sponsors at the events, and with past and future events in the family. Sponsors are able to target demographics, geography and themes in a systematic plan taking into account timing, rights activation and budget. The system takes advantage of the goodwill and momentum generated by one event to propel attendees into the next simultaneous or contiguous events. The system also includes auditing, evaluating and adjusting the marketing in real time as the campaign unfolds for maximum return on the investment.

The system may be applied to surround any “sponsorable event” with mass media marketing, a “sponsorable event” being any community event capable of offering marketing to consumers, such as radio, television and web broadcast advertising, signs and billboards, messaging via email, text messaging and web messaging, distribution of printed materials or brand name inclusion in media presentations and in-person contacts. Advantageous examples are festivals and fairs.

While the disclosed system may be used to treat any single event, it is particularly beneficially used on families of events. Families of events or communities of events are collections of festivals and events, treated with the disclosed surrounding media system that are chosen to meet a sponsor's reach, geographic, demographic and impression depth objectives across markets overtime. The combination of events into families of events turn a single, local marketing project into a strategic marketing program that provides deep brand-building exposure, delivers qualified consumer prospects, and provides measurable results for marketing management.

To attract national sponsors, individual events treated with the disclosed method are organized into planned families of events, based on the one or more sponsors' reach, geographic, demographic and impression depth objectives. Planned families of events require no additional effort on the part of the individual event promoters and represent opportunity to deliver new sources of revenue to each event.

Event promoters may initiate interaction with the system or, more commonly, sponsors begin the process. Event promoters select prospective sponsors and request negotiation. Sponsors may be previously chosen or selected by search criteria. Sponsor data is entered and maintained in databases within the system or accessed through programmatic devices well known in the art, such as web crawlers, spiders and data miners, or any device for information gathering now known or later developed. For example, a community event is planned by the local tilth society: a bluegrass music festival. The tilth society begins the process by choosing a search criteria for sponsors limiting the search to those companies providing earth friendly products or services. A search is run and a list of prospective sponsors returned, sponsors such as Seventh Generation, Giaim, and Cedar Grove Compost. The festival promoters choose a list of most desirable sponsors and sponsorship rights are negotiated, purchased and delivered to them. Since sponsors can be approached simultaneously, negotiations become vastly more efficient with a higher potential for maximizing sponsorship fees. For example, Seventh Generation Corporation might be more interested in sponsorship if they knew that Giaim Product Company was also interested and the two company's names could be associated.

Alternatively, and more commonly, the process begins with one or more sponsors by selecting sponsorable events and placing them into an event community according to each sponsor's strategic event focus. Event focus is created using demographic, geographic and consumer reach preferences, as well as activation and budget requirements. Optimally, the system includes using collected information about events over past years, organized and categorized to facilitate identification of target demographics. Such information is maintained in databases within the system or accessed through programmatic devices well known in the art, such as web crawlers, spiders and data miners, or any device for information gathering now known or later developed. An individual event or family of events are selected with an eye towards maximizing the sponsors “effective reach” and organizing a framework for systematic development of target markets. The system maximizes both efficient consumer access and broad consumer reach.

For example, say the system is used to develop a family of events sponsorship program for a well known cell phone provider. Personnel implementing the system work with the cell phone company personnel identifying the prospect demographics. It is decided to target young adults 20 to 34, and teens 12 to 18, drawing in their parents 35 to 55. Young adults 20 to 34 should have annual incomes greater than $24,000. Teens should have disposable income greater than $400/month during the school year. Both new customers and existing customers available for upgrades in services are sought. For geographical considerations, the Colorado market is identified by the cell phone company as a viable market since it has good digital signal distribution and a reasonable population base of potential customers. As part of the system, proposed budget ranges are balanced with consumer reach potentials and an optimized target exposure is determined. Target exposures are set at reaching 606,400 prospects with 9.3 million broadcast impressions over a period of 6 months, 7.4 million web impressions over the same period and 171,475 in-person contacts. It is planned to deliver 9,130 qualified prospects at a program cost per signed customer of $45 to $65.

Continuing this example, as part of the process, consideration is given the demographics, desired target reach and the Colorado market. Turning to the system databases, comparative analysis is performed on the statistics stored for repeating events and, in the case of new events, similar events. For example, attendance records, demographic statistics and sales records for previous sponsors and promoters is some of the data analyzed. From this analysis a family of events is identified as the combination most optimized to provide repeat broadcast impressions across the entire addressable market of the identified preferred prospects. Four festivals that attract a projected total of 775,000 attendees are proposed. Festival 1 is the Spring Fling with average attendance over the last 5 years of 40,000. Festival 2 is Bluegrass on the River with average attendance of 250,000. Festival 3 is the Chile & Frijoles Festival, and so forth. Initial construction of the surrounding media treatments and expected customer prospect returns for the festivals is also speculatively designed.

Once a single event or a family of events is selected, the sponsorship rights are negotiated, purchased and delivered. Optimally, festival sponsorship rights negotiation and sponsorship activation services may be contracted for individually or in combination. Since event promoters within the industry of community events span a wide spectrum of marketing experience (or inexperience), negotiation of sponsorship rights can be frustrating and an inefficient use of a sponsor's marketing dollars. The disclosed system streamlines negotiations and provides sponsors efficient access to the marketing potential of community events with effective coordinated negotiations and coordinated placement fees. Using the example above, say the promoters of Festival 1 have an inflated idea of the value of a primary sponsor spot for their festival. Estimated exposure rates indicate that Festival 1 will probably deliver 442 qualified prospects, while Festival 3 will deliver 2,700 qualified prospects. This may lead the negotiators to eliminate Festival 1 from the family of events replacing it with a festival of equal recorded performance in prospect return. On the other hand, if previous seasons metrics recorded in the systems databases indicate that Festival 1 has a strong effect on the attendance of Festival 3 and the target reach of Festival 3 sponsors, they may increase the budget for Festival 1 sponsorship. Thus, coordinating negotiations and coordinating placement fees can result in a more intelligent use of marketing funds.

Another negotiation benefit of the system is that the system offers sponsors and promoters a substantial increase in benefits for the same budget. System negotiators can offer to exchange branded entertainment television programs and web content featuring the sponsored festivals in exchange for sponsorship rights. The discovery that a program's surrounding media benefits events by increasing attendance, elevating the value of their other sponsorship positions, providing the events new sponsorship marketing materials and creating community status is a new and powerful negotiating tool.

Once the pairing of sponsors and events or event communities has been accomplished, activation programs are developed to maximize the value of sponsorship investment. The disclosed process and method are an integration of mass media promotion, personalized messaging, website services, on-site event sales activation and media presentation filmed during the events, which surrounds both the community event and consumer. The process transforms an individual community event into a 4 to 6 week sponsorship campaign that engages the consumer with a process to simultaneously build brand, qualify prospects, convert prospects to customers, and support customer service.

The disclosed system deploys an integrated multimedia campaign organized into a custom sales “funnel”. This funnel can be described as a 3 stage consumer relationship development, which casts a wide net at one end reaching as many prospects as allowed by the system constraints of budget and specific program design, then narrows or funnels those prospects into a profitable relationship with both event sponsors and the event itself. Prospects are funneled into the campaign at the widest media distribution with “prospect development”,then hooked to continue towards a relationship with “consumer engagement” and, at the outlet of the funnel, drawn into a lasting consumer relationship through “relationship development”. Prospect development combines on-air radio and television broadcasts, online web presence and on ground contact through chamber of commerce tours and contact at the community events themselves. Once prospects are gathered, consumer engagement is accomplished through personal messaging to prospects through various technologies, website contest participation by prospects, targeted advertising during website community event research by prospects and by prospects visiting booths at the community events. Lasting prospect relationships are developed through personal contact with the prospects at chamber of commerce tours, engagement of prospects at the community events and a post event television broadcast featuring the community event attendees.

The disclosed system optimally includes an interactive website. Advantageously, the promotional programs on the website begin 7 to 10 days before the event to motivate attendance at the event and initiate the sponsors campaign. Advantageously, the website offers event promoters, attendees and sponsors many services that attract them to the website and promote revisiting the website.

One of the most beneficial services is event and festival information storage and retrieval. Advantageously, the system supplies the means for entry of an event on the website free of charge. This encourages promoters to enter information relating to their community event themselves. Alternatively, event information is presented on the website through any information storage or retrieval methods now known or later to be developed. The result is that event attendees can search among tens of thousands of festivals listed and described on the website.

Visitors to the website advantageously search for events through one of several methods available. Website guests may search for an event by geographic drilling down-the practice of clicking on a world map to select a country, then clicking on that country's map to select a region, clicking on that region's map to select a city and so forth, until they have narrowed their search to the geographic area they desire. Then visitors select to see a list of all the events available for the area. Alternatively, location names may be typed in to return search results. Similarly, searches may also be done by keyword (such as an event name, or “Bluegrass”) or category (such as “arts”,“music”,“sports” or “kids”). In preferred systems, search methods may be combined to narrow the search and decrease returned results. For example, a location, keyword or category may be combined with a specific month or date range request.

Advantageously, search results are returned as lists, each event listed with name, dates and location. In preferred embodiments, events can be noted as featured events or ranked with stars or other methods of recommendation. Optimally, the number of events returned by a search is displayed to visitors and large numbers of events are divided into separate screens or “pages” with navigation tools provided to quickly navigate between pages.

Optimally, visitors who conduct searches that return an event that is also part of a family of events will be presented with information, promotions and advertising regarding the other events in the family. In this way, interest or attendance at one event in a family is used to promote the upcoming events in the family.

Events are preferably listed with detail buttons that when clicked take visitors of the website to pages of detailed descriptions of the selected event. Detailed descriptions advantageously include the name, location, dates, admission costs, parking costs and directions, a description of the event, schedules of events within the event, directions to the event, links to an image gallery or photos, and contact information for the event. Contact information advantageously contains contact names, addresses, phone numbers, dynamic links to event websites and dynamic email addresses.

As part of the disclosed system, one or more contests are run on the website. Website visitors may identify upcoming festivals and enter contests to win free tickets to the event they have identified. Alternate contest prizes are free tickets to upcoming community events in the family of events being promoted, “giveaways” of sponsor's products or services or “VIP” packages to upcoming events which include special products or services at the event, or meetings with performers at the event. Prizes may be distributed at booths at the event, thereby encouraging event attendance and bringing prospects into personal contact with booth personnel for the purposes of promoting sponsors' brands and gathering demographic and contact data.

Optimally, the website offers other services that attract visitors and encourage them to visit the website at regular intervals. For example, visitors may view a photo gallery (image gallery) of both promotional material submitted by community event promoters or sponsors and photos taken as part of the disclosed system at the event. Event attendees are highly motivated after the event to visit the photo gallery to see if their participation has been captured and posted. Another example is a kids section included in the website with material scaled and displayed to a children's audience. Examples of such material include interactive games, puzzles and cartoons as well as displays for special community events, performers and services geared to children.

In addition, the website advantageously contains features that serve community event promoters and sponsors. As visitors navigate throughout the website, showcases are displayed of a featured festival, featured sponsor, featured supplier and/or featured performer. Each of these showcases contains a link to detailed information about the feature. For example, in the case of a performer, performer description, geographic area, scheduled appearances and contact information is displayed, and a link to an image gallery is provided. If a featured festival, sponsor, supplier or performer is scheduled into an event that is part of a family of events, the entire family of events is advantageously promoted along with the featured item when the visitor clicks the link.

Another advantageous service provided on the website is a “Backstage” forum allowing marketing of backstage services to the event spenders and suppliers. These backstage services provide a vendor with a full page listing on the website, advertising to consumers, product listings with pictures, contact information for consumers and a link to the supplier's website. This provides a way for the customer to find vendors after the closing of the event and reduces administrative overhead for community event planners and promoters.

As the process progresses, in advance of the event, radio and/or television broadcast messages are transmitted to create awareness of the event and to connect one or more sponsors to the event. Broadcast messages also motivate the listener to visit the website to learn more about the event, to search the website's database of upcoming events and to register to win a trip to an event. Broadcast messages also encourage the listener to visit representatives at the specified booth at the event to receive promotional codes that can be entered on the website to improve the registrant's chances at winning a trip to an event they have identified by searching the website's database of upcoming events. The promotional codes that are handed to the attendees by representatives are given to the attendees according to the different demographic categories identified by the one or more sponsors who have activated the process. When the attendees are given the codes, they are encouraged to go to the website and enter the code to win the trip to an event they choose. After the attendees enter the codes that uniquely identify them by their demographic category, subsequent advertising messages that are presented as the attendees view the content on the website are advantageously specific to the demographic category identified by the code received at the event.

Optionally, a chamber of commerce tour is implemented to develop a sense of community around the one or more sponsors' brands. The tour is designed to engage the small communities in the sponsors' chosen demographic markets and promote attendance to one or more of a family of events. Specifically, at organized tour stops, large groups of attendees are filmed while chanting, “Hello from town X,” and, “We vote Brand X.” The film is edited continually as the tour progresses and played at other stops during the remainder of the tour. Optionally, chamber of commerce tour attendees are also interviewed for demographic information and given promotional codes to increase their chances of winning a contest on the website. At this time personnel also gather attendance and exposure data for the process evaluation to be used for redesigning resource allocation in the process as it is applied to future events in the family of events. For example, using the example above, a chamber of commerce tour is designed for the cell phone sponsored family of events because of the large number of rural towns in the Colorado market. Since the market is geographically challenging due to incongruent cell coverage, it is decided to schedule stops specifically at 22 towns that have cell phone coverage. An estimated 40,000 additional attendees will be exposed during the tour, and directed to the festival, the post event television program and the website.

Preferably, chamber of commerce tour attendees are motivated to watch the post event television shows. Guest hosts are a feature of the shows and the chamber of commerce tour activities are advantageously integrated with guest host auditions. Voting is conducted through dynamic website, email, phone or text messaging, allowing participants to nominate and vote for their choice of guest host. Optimally, voters are given promotion codes to enter allowing them to vote. This advantageously directs consumer prospects to the website and post event television show where they receive more repeat impressions for the sponsor and upcoming community events that are part of the event family. Again, which advertising and repeat impressions are delivered on the website are targetable to the specific demographic of the visitor as indicated by the promotion code they enter. It is possible that a subset of the prospects do not have Internet access. Optimally, an effort is made to identify resources within the towns, including libraries and school resources, that are accessible to the general public and to direct tour attendees to such resources.

When a family of events is planned within the system, guest host auditions are also advantageously offered and conducted from the events. For example, a group of young girls is attending the Spring Fling in Colorado. They are filmed giving a sales pitch that one of them be the guest host for the upcoming broadcast of the Spring Fling festival film or the upcoming Bluegrass on the River festival film. This film clip is posted to a system website, where the girls can direct their friends to watch their clip and vote for the candidate. Website visitors who access the clip are then displayed demographic specific advertising, based on the candidate's demographic, geography and which event the candidate was attending. All voters will watch the festival film broadcast and this fact influences the advertising included in the broadcast.

In preferred embodiments, attendees participation and other event activity is filmed or recorded during the event and used to create a media presentation such as a television program. While this media presentation is hereafter referred to as a “television program”,it should be understood that in the context of this application, the media presentation may be a web-cast, distributable video tape, CD, DVD, or any similar media presentation now known or later developed. The television program advantageously captures the fun, color, pageantry and excitement as communities celebrate. This associates the sponsors brand with the fun and celebration of real people and a real life community event such as a festival, providing sponsors with a personal relationship to prospective customers like no other marketing opportunity. In addition, if the community event is an annual or frequent event, the television program provides a reinforcement of the success of event attendance and an impetus for attendees to return next year. Advantageously, community event promoters and producers are consulted during the creation of the event's television program, to identify key aspects to be highlighted. The television program is generally aired from 1 to 8 weeks after the event.

Optimally, radio and/or television broadcast messages continue throughout the event prompting attendance, connecting the sponsors' brands to the event and directing prospects to visit the website, see representatives at one or more booths at the event and watch the post event television program. In addition, messages are sent out to specific prospects from whom contact data has been collected during the chamber of commerce tour, during website usage or in person during previous events. In addition, sponsors or promoters may contribute contact data. Messages may be sent by e-mail, Internet messaging, phone, phone text messaging or any other technology now known or later developed. Messages may contain the special promotional codes, which motivate a prospect to visit the website by increasing the user's chances of winning a contest. Again, subsequent advertising messages that are presented as the prospects view the content on the website are optimally specific to the demographic category identified by the code received in the message.

Meanwhile, event attendees make contact at the event with sponsor related personnel at special locations. While the special locations at the event where in-person contact is made with prospects are hereafter referred to as “booths”,it should be understood that in the context of this application, in-person contact at the event may be made at a table in an exhibition building, at ticket sales windows, in line for rides, during the rides,.over a computer screen through Internet meeting, at moving locations around the fair grounds, from a hot air balloon or any other location where a conversation may take place and information be exchanged. As outlined above, radio, television, website and messaging direct prospects to the booths to receive promotional giveaways, vote for a television program guest host, audition as a guest host or receive promotional codes to enter on the website for contest entry. The booth personnel promote the sponsor's products or services, encourage them to attend other festivals in the family and, at the same time, gather demographic data from the event attendees. The promotional codes given the attendees are related to the demographic data gathered. As described above, when the attendees are given the codes, they are encouraged to go to the website and enter the code to vote for guest hosts or enter contests. After the attendees enter the codes that uniquely identify them by their demographic category, subsequent advertising messages that are presented are specific to the demographic category identified by the code received at the event. The booth personnel also direct the attendees to view the post event television program where contest winners and guest hosts will be announced. At this time personnel also gather attendance and exposure data for process evaluation to be used for designing the process details for future events in the family of events.

Individual sponsors may have booths or special sites at the event separate from the booths for in-person contact that are part of this system and method. This allows for a redirect of each sponsor's prospects to the sponsor's booth or booths for special attention. For example, a family of festivals has been identified and this process put in place for a major cell phone provider. Individuals have been directed to a booth at the first event identified as the “Festivals Whoopee” booth, through the website, radio and television advertising and a chamber of commerce tour. System personnel greet individuals at the “Festivals Whoopee” booth, qualify them as either existing customers of the cell phone provider, viable prospects or those outside of the cell phone provider's coverage areas. Existing customers of the cell phone provider are further qualified as either satisfied or unsatisfied. The cell phone provider is operating two distinct separately located booths at each event in the family where sales prospects and unhappy customers are directed by “Festivals Whoopee” personnel. The cell phone provider's sales personnel receive highly qualified prospects. Even if the prospects do not sign up at the cell phone provider's booth, the process of showing them optional phones and collecting information about their phone preferences enables subsequent conversion to customer status through further marketing by the cell phone provider. Meanwhile, unhappy customers are serviced with special attention for retention at a separate booth, effectively separating unhappy customers from sales prospects.

Optimally, during the event, the website is synchronized to promote the event, the future events in the event family, the post event television program and key sponsors and suppliers. The promotional programs discussed above draw consumers to the website where they learn more about the event and apply to enter one or more contests. Visits to the website generate substantial impressions for the event and the one or more sponsors.

After the event, promotion continues attracting attendees and others to the website where they may enter special codes they received during the event, continue searching for future festivals in the family or outside the family, or vote in response to a promotional campaign, such as the guest host auditions.

In preferred systems, after the event has closed and prior to the airing of the television program featuring the event, the website, one or more sponsors and the television program are promoted via television and radio broadcast messages and through electronic messaging. Such promotion may, at this time, release promotional codes that increase the opportunity to win one or more contests offered on the website. Web visitors are still invited to search through the website's offerings of events. During this search process, the sponsors advertising messages are presented to the web attendees.

From 1 to 8 weeks after the event, optimally about 3 weeks after the event, the television program is aired on a channel selected to correspond with the one or more sponsors' demographic objectives. There are many reasons for event attendees and potential customers to view the television program. Some will watch to relive the fun and celebration of the event. Many will watch to see if they have been given a moment in the spotlight. If a guest host contest was run, some will watch to see if their candidate for the guest host won a hosting position on this or some future festival's program. It is highly likely voters will watch to see their candidate host the program. Also, during the television show, one or more winners of the contests for free tickets or other promotional prizes are announced. All potential prospects, those who attended the event, those who attended chamber of commerce tours, those who were contacted through electronic messaging and in-person at the event, and those who merely were exposed to radio and television promotional messages, will be directed to watch the post event television program. During the television program, sponsors are connected with the fun and pageantry of the event, and highlighted as the provider of the contest prizes. Other event sponsors and suppliers also have an opportunity to participate in the television program sponsorship. In addition, future events in the event family will be promoted. If the event is a recurring event, prospects will be encouraged to attend the next recurrence.

After the television program, the community event promoters and sponsors advantageously send thank you electronic messages (such as Internet messages, e-mail, and phone text messaging) to website visitors who are registered for the promotional programs.

The promotional programs surrounding an event are advantageously designed to incorporate measurement and reporting. Optimally, after the event, collected information, such as event attendance, rights fulfillment and demographic values, are audited, analyzed and reported, allowing for continuous program improvement over time. This is especially beneficial if the event is part of a family of events with upcoming events remaining. Radio and television messaging have projected audience data. The number of electronic messages sent before, during and after the event are advantageously recorded. Visitors to the website are advantageously counted and tracked as to their specific activities on the website. For example, numbers are collected indicating how many visitors used a link to a sponsor's website or a link to a future event in the family of events. If the website visitor entered promotional codes, they are identified and counted according to demographic category. Exposure to demographically specific advertising while a website visitor viewed the site is also tracked. The attendance statistics of the event are recorded and the number of in-person contacts that were made is recorded and further sorted according to demographic categories. Voting statistics for guest host contests are recorded whether by website, email, phone or electronic messaging, and demographic numbers associated with those statistics. The abundance of exposure data inherent in the system allows for implementation of quality control metrics for improvements in program performance overtime. For example, during the post event audit of performance metrics after Festival 1 of a four festival family, it is noted that while an equal number of promotional codes were handed out at chamber of commerce tour stops in towns between 25,000 and 35,000 in population, only 5% were used. While in towns of populations of less than 25,000 and greater than 35,000, 30% or more of the promotion codes were used. Future stops on the chamber of commerce tours that fall within the 25,000 to 35,000 population range are then eliminated and replaced with towns anticipated to be more productive.

Using the disclosed system and method, promotion does not stop at the close of the event. With the disclosed system and method, the consumer and the event are surrounded by multimedia repeat impression promotion that extends and enhances traditional programs. The result is a significant increase in the number of impressions provided to sponsors for a single event and a springboard continuation of promotional activities into the events remaining in an event family.

The above disclosed system provides an event community of one or more events where promoters and sponsors are linked to one another and to at least one event in mass media advertising. For example, an event and its sponsors are linked and promoted on a website for the event.

Various elements of the system disclosed include at least one computer or server operatively connected to a distributed network and hosting an event Internet site. The event Internet site is operatively connected to at least one information source of event content, such as a database. Also included is at least one input device through which a user accesses the event Internet site and inputs data and at least one output device through which a user accesses the event Internet site and receives selected output. In addition the system contains an application running on the event Internet site server, wherein the application is adapted to receive search criteria input from a user, return search results of event information, receive event content from a user and display advertising to a user based on user input.

Another element sometimes included in the system is a subsystem for providing a contest to contest participants. As part of the subsystem there is at least one input device through which a user inputs contest data and at least one output device through which a user receives selected contest output. The server application receives contest data input from a user, returns advertising to a user based on user input, stores contest data on computer readable media, selects a contest winner from stored contest data, and generates electronic messaging using contest data.

Another element generally included in the system is a media presentation, such as a film or television show, composed during each event of participation in each event and distributed or broadcast after each event.

Also disclosed as sometimes included in the system is a chamber of commerce tour with one or more tour stops. Media or live presentations are delivered to an audience according to a presentation schedule at geographically related sites with various types of audience participation, such as chanting, filming of a media presentation composed during each tour stop (the media presentation is then presented at succeeding tour stops), entering a contest, filming of election candidates, voting in an election, discussion of events and sponsors and distribution of promotional codes.

In the disclosed system, generally, the mass media advertising occurs before, during and after the event, in combination or singly. Also disclosed is an event community where an event and its sponsors are linked and promoted through a media event occurring after the close of each individual event.

The system disclosed above serves marketing, sales and promotional needs of community event promoters and sponsors, particularly community events such as festivals and fairs. The system integrates radio advertising, television advertising, an Internet website, electronic messaging, in-person interaction, a chamber of commerce tour and specially filmed media presentations, providing a many faceted environment of multimedia and in-person impressions. The website offers contest participation, search capabilities for the location of events, event, sponsor, promoter and performer showcases and a backstage services locator. Plus, elements of the system are implemented before, during and after events to surround the event and its attendees with event advertising and sponsor impressions. The system increases event attendance, creates an advantageous connection of the fun and celebration of a festival or event to sponsors and extends the marketing potential beyond the dates of the event.

### BRIEF DESCRIPTION OF THE DRAWINGS

FIG. 1 is a diagram of a preferred embodiment of the disclosed system.

FIG. 2 is a flowchart of a process within the disclosed system.

FIG. 3 is a flowchart of a process within the disclosed system.

FIG. 4 is a flowchart of a process within the disclosed system.

FIG. 5 is a diagram of a preferred embodiment of the disclosed system.

FIG. 6 is a diagram of a preferred embodiment of the disclosed system.

FIG. 7 is a comparison of a traditional system with that of the disclosed system through the use of 2 flowcharts.

FIG. 8a and 8b are 2 diagrams comparing a traditional system with that of the disclosed system.

FIG. 9 is a diagram of a preferred embodiment of the disclosed system.

FIG. 10 is a schematic of an initial page in a website which is part of a preferred embodiment of the disclosed system.

### BEST MODE OF CARRYING OUT THE INVENTION

The system may be applied to any “sponsorable event”,a “sponsorable event” being any community event capable of offering mass media marketing to consumers. The term “mass media” as used within this application should be understood to include television, radio, webcast, computer display through a distributed network of computers, conventional print, signs and billboards, email, text messaging, Internet messaging and other such media means of distributing information to a plurality of consumers, whether now known or later developed. Sponsorable events may be combined into “family of events”,also referred to as a “community of events”. Families of events or communities of events are collections of festivals and events, treated with the disclosed surrounding media system that are chosen to meet a sponsor's reach, geographic, demographic and impression depth objectives across markets over time. In preferred embodiments, attendees participation and other event activity is filmed or recorded during the event and used to create a media presentation such as a television program. While this media presentation is often referred to in this application as a “television program”,it should be understood that in the context of this application, the media presentation may be a web-cast, distributable video tape, CD, DVD, or any similar media presentation now known or later developed. It should also be understood that, in the context of this application, a “kiosk” or “booth” may be any location where in-person contact or a conversation may take place and information be exchanged between system personnel and prospective customers.

Turning now to the drawings, the system will be described in preferred embodiments by reference to the numerals of the drawing figures wherein like numbers indicate like parts.

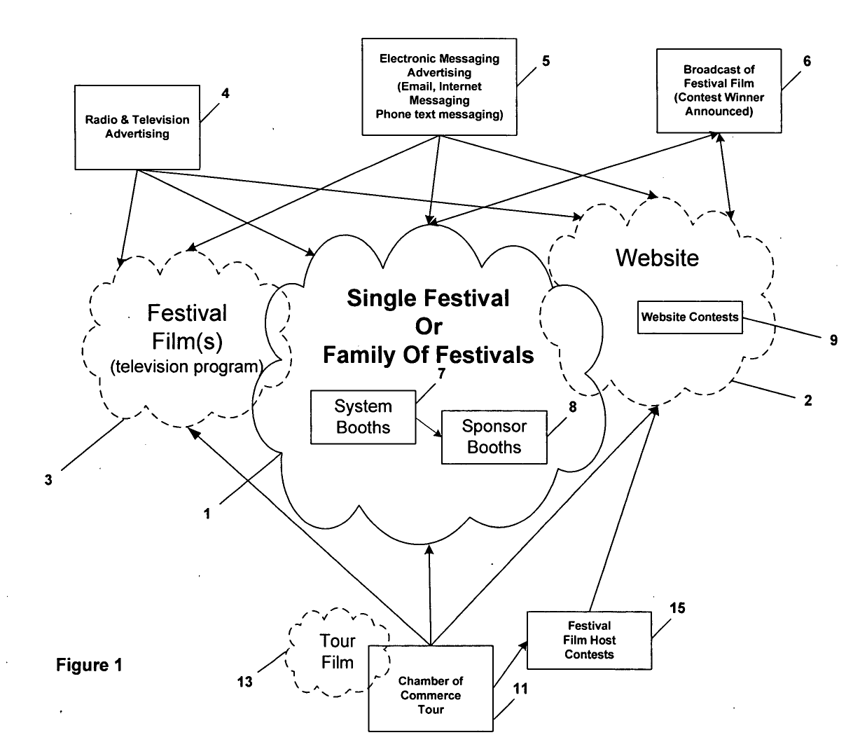

FIG. 1 is an overview diagram of a preferred embodiment of the system. The surrounding mass media marketing system may be applied to a single community festival or family of festivals 1. For the purpose of simplifying the language of the discussion of FIG. 1, element 1 will be referred to as a single event; however, it should be understood that the same system is used for a family of festivals. There is desirably an interdependency between festival 1 and website 2 and likewise between festival 1 and festival film 3. Website 2 is interlinked to festival 1 by providing detailed information about the festival, a photo gallery of shots from the festival, contests for free admission or other festival specific prizes, details on performers, sponsors and products, and a means for searching through multiple festivals that points potential attendees to the festival. In addition to directing website visitors to festival 1, the website directs visitors to watch broadcast 6. Reciprocally, during broadcast 6, viewers are directed to visit website 2 and partake of its many services. Festival film 3 is interlinked with festival 1 as it is usually created live at the festival, recording the fun, pageantry and excitement of the event. During the festival, festival film 3 is advantageously evolving with ongoing fresh footage. Optionally, there is more than one festival film 3 recorded and then broadcast for a single event. Advantageously, there is more than one festival film 3 for a family of events, each event having it's own film or films, each film with it's own one or more broadcasts 6.

Surrounding the three central elements, festival 1, website 2 and festival film 3, are radio and television advertising 4, electronic messaging 5, chamber of commerce tour 11 and, as previously mentioned, broadcasting of a festival film 6. Each of these elements directs listeners, viewers or tour participants to attend festival 1, participate in festival film 3 or visit website 2.

At the festival, there is a system booth 7. As defined above, it should be understood that, in the context of this application, a “kiosk” or “booth” may be any location where in-person contact or a conversation may take place and information be exchanged between system personnel and prospective customers. Prospects who visit system booth 7 are directed to be filmed at the festival for festival film 3, watch broadcast 6 and visit website 2 to partake in website contest 9 or festival film host contest 15. FIG. 1 illustrates how the surrounding media is interrelated. When a prospect enters the system through any one conduit, they are continually directed to ongoing engagement and relationship building through the other media elements and subsequent festivals within the family.

In addition to system booth 7, there is advantageously one or more sponsor booths 8. This allows personnel from system booth 7 to direct prospects to booth 8 staffed by a sponsor's customer service personnel for specific assistance.

Chamber of commerce tour 11 creates mini events throughout communities surrounding festival 1 in time and space. Additions are made to an evolving film of the tour (tour film 13) at each stop on chamber of commerce tour 11. Advantageously, festival film host contest 15 is also run, where prospects are encouraged to visit website 2 and vote for their favorite host candidate.

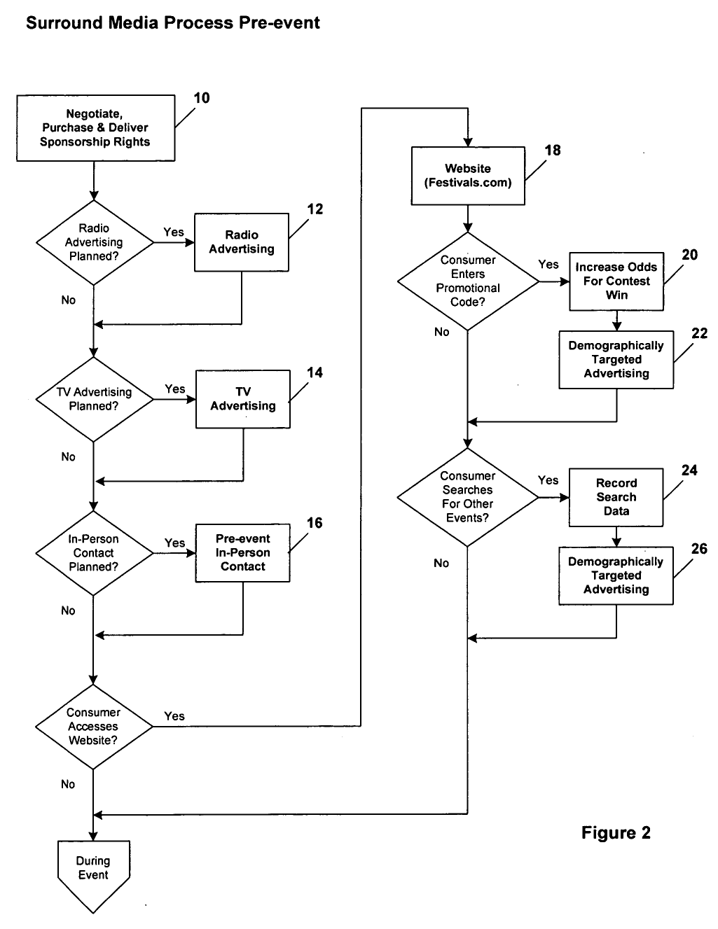

FIGS. 2, 3 and 4 illustrate the creation and delivery of media surrounding a single event before, during and after the event's dates. The process illustrated is accomplished within a preferred embodiment of the disclosed system and may be applied sequentially to multiple events carefully interrelated into an event family, as described above.

The flowchart of FIG. 2 illustrates the creation and delivery of media surrounding an event prior to the event's opening date. The beginning step is the negotiation, purchase and delivery of sponsorship rights 10. Once rights are negotiated, a marketing program is planned. If pre-event radio advertising is planned, radio advertisements 12 are aired. Likewise, if pre-event television advertising is planned, television advertisements 14 are aired. Pre-event in-person contact with prospects 16 may be planned as occurring through a chamber of commerce tour, at a previous event in a family of events, at booths in public places such as shopping malls or in any method whereby prospects may be engaged in conversation or personally handed promotional materials. As a result of these steps, or through their own initiative, consumers may visit the system website 18. If a website visitor has been given a promotional code through one of the previous steps, they can enter it and increase the odds of winning a contest 20. The system can then use the code to display demographically targeted advertising 22. While on the system the visitor may decide to search for events. Should they do so, search data is recorded 24 and, based upon this data, demographically targeted advertising 26 is displayed. At this point, the event opens and the process continues with surrounding media exposure during the event.

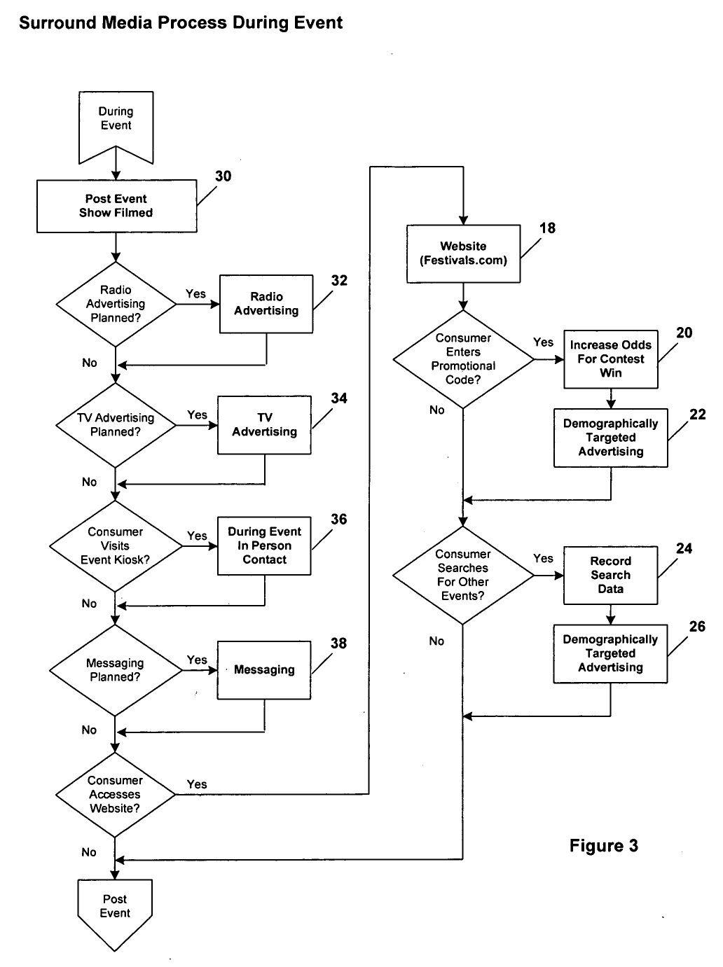

FIG. 3 is a flowchart of a process in a preferred embodiment of the disclosed system which occurs during the event. It is during the event that the post event media presentation or show, such as a television show, is filmed 30. If radio advertising in planned, it is evolved into radio advertising suitable for during the event and aired 32. Television advertising is aired 34 in form also suitable for during the event. In-person contact is now possible through event attendees visiting special system kiosks or booths 36. During the event is an advantageous time to begin electronic messaging 38. Through any of these steps a prospect may be given promotional codes or in some other way motivated to visit the system website 18. Steps 20, 22, 24 and 26, as described in the description of FIG. 2 above, are then possible. Once the event closes, the process advantageously continues with post event processing.

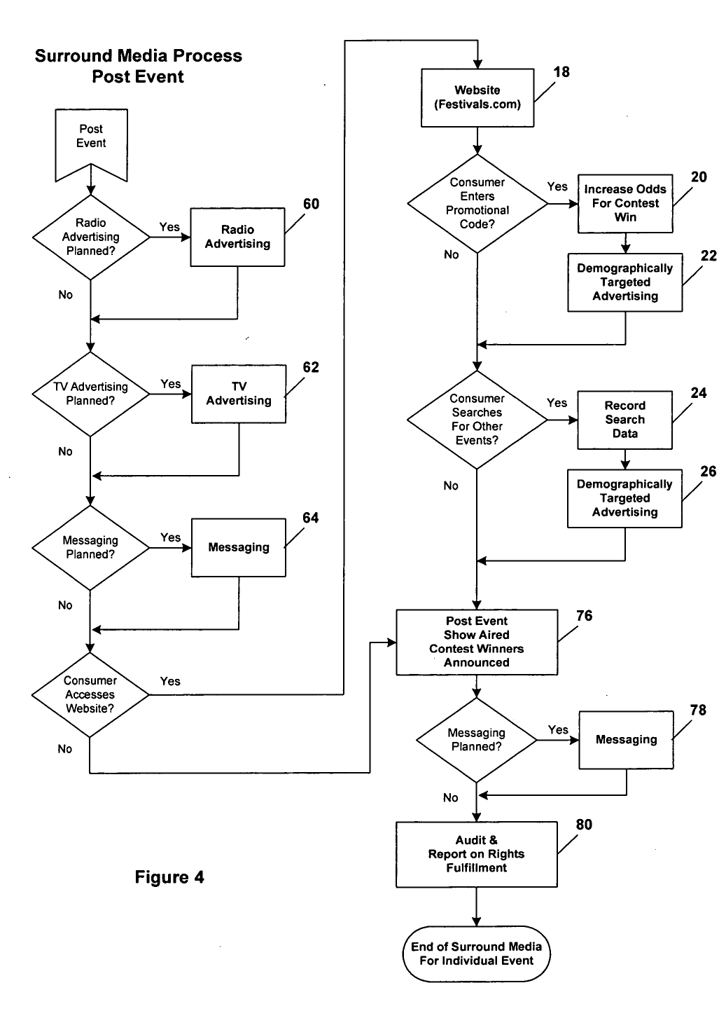

FIG. 4 is a flowchart of a process in a preferred embodiment of the disclosed system which occurs after the event. Radio advertising 60, television advertising 62 and electronic messaging 64 are aimed at directing consumers to visit the website 18 and watch the post event broadcasts 76 of the festival film. Consumers are still encouraged to enter promotional codes on the website to increase the odds of winning a contest 20, shown demographically targeted advertising 22 and search for other events while search data is recorded 24,which in turn produces more demographically targeted advertising 26. Visitors to the website can always enter contests for upcoming prizes 20. At the optimum time after the event closes, deemed 3 weeks in most cases, the post event show is aired and the contest winners announced 76. Following the airing of the show, more electronic messaging 78 may be planned,the messages notifying prospects of the winners, advertising future events in the family and future sponsors. The final step in this embodiment of the system is to perform audits and report on rights fulfillment 80. If the process has been performed on one of a family of events, with future events upcoming, these audits and reports are then used to fine tune the next iteration of the process, i.e. designing the next event's marketing plan.

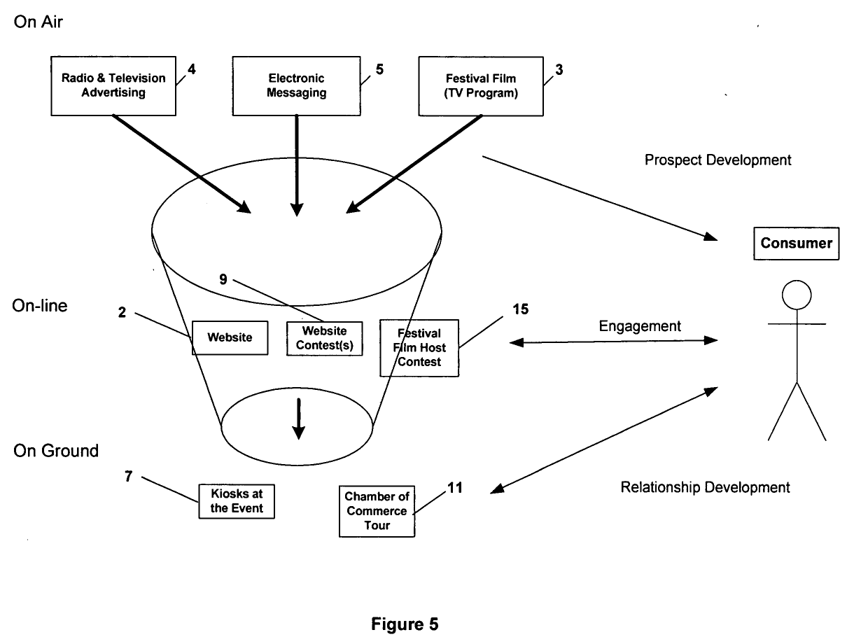

FIG. 5 is a diagram illustrating a sales “funnel” described above in the section titled “Disclosure of the Invention”. Illustrated are 3 stages of customer development. The first stage utilizes on-air marketing for prospect development. It includes radio and television advertising 4, electronic messaging 5 and festival film 3. The on-air stage is unidirectional, not interactive with the consumer, while the later stages are. It involves the methods of making initial contact with the consumer, peaking their interest and bringing them into the funnel, where they are channeled towards becoming an event attendee and a customer of the event sponsors. The next stage, the middle stage, utilizes on-line, Internet, wireless communications or telephone based interaction with the consumer to engage them in activity. For example, participation by voting in festival film host contest 15 can take place through any of these on-line methods. The middle stage also includes website 2, where a consumer takes advantage of many services and/or enters one or more website contests 9. In the last stage, on-ground personal contact takes place at kiosks at the event 7 or at stops in chamber of commerce tour 11. This stage works on relationship development at the personal level and has the greatest potential for converting a consumer into a future event attendee or sponsor customer.

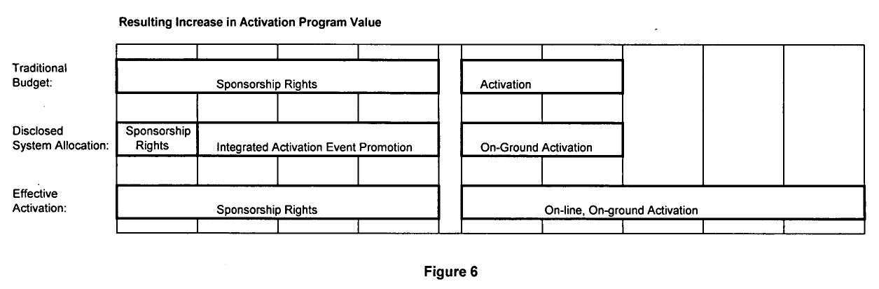

FIG. 6 illustrates how the disclosed system increases the effectiveness of marketing or an activation program value for the same budget. A division of budget is illustrated for a traditional budget applied through a conventional sponsorship system as 4 parts spent on sponsorship rights and 2 parts spent on the activation of the program. Using the disclosed system, sponsorship rights are assigned only 1 part of the available budget, since the choosing of events is focused, using demographic, geographic and consumer reach preferences, and since the disclosed system utilizes systematic negotiations and coordinated placement fees that reflect the true value of each events marketing potential. This leaves 3 parts of the budget for integrated activation event promotion and 2 parts for on-ground activation. Since the sponsor has achieved the same effective sponsorship rights at less budget investment, the effective activation program value, or marketing effect, is equal to that of a budget with 3 parts more investment than if the money were used in a traditional sponsorship system.

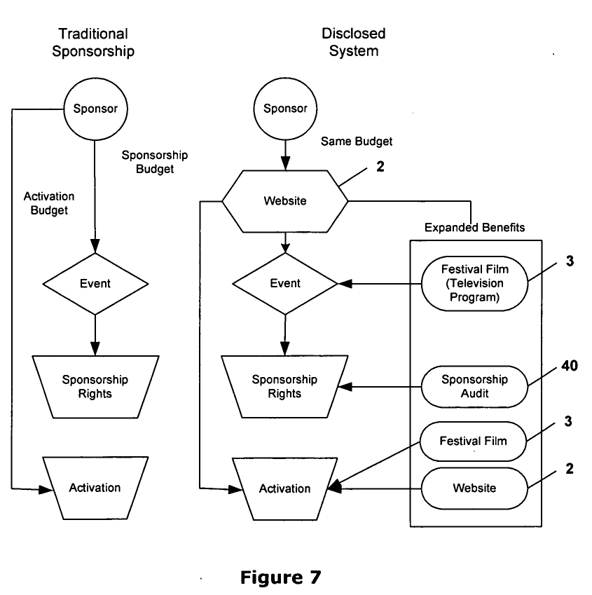

FIG. 7 also illustrates how the disclosed system increases the effectiveness of marketing or an activation program value for the same budget. The flow chart on the left illustrates a traditional sponsorship method. A sponsor chooses an event and negotiates the sponsorship rights according to a sponsorship budget, then applies their activation budget to activate a marketing campaign tied to the event. In the flow chart on the right, it is illustrated that with the disclosed systems methodology the sponsor enjoys substantially expanded benefits for the same budget. Immediately, the sponsor can be promoted on system website 2, even before events are chosen, opening the sponsor to solicitations from event promoters placing sponsors in a better negotiation position. Festival film 3 is produced around the event, extending the sponsor's activation time beyond the close of the event and expanding the sponsor's reach through contests and festival film participation. Sponsorship audit 40 is performed using the systems information retrieval system to obtain relevant attendance records, impression figures and previous sponsors rights fulfillment data for each considered event and this informs the sponsorship rights negotiation. Both the on-line promotion of website 2 and festival film 3 greatly enhance the activation campaign.

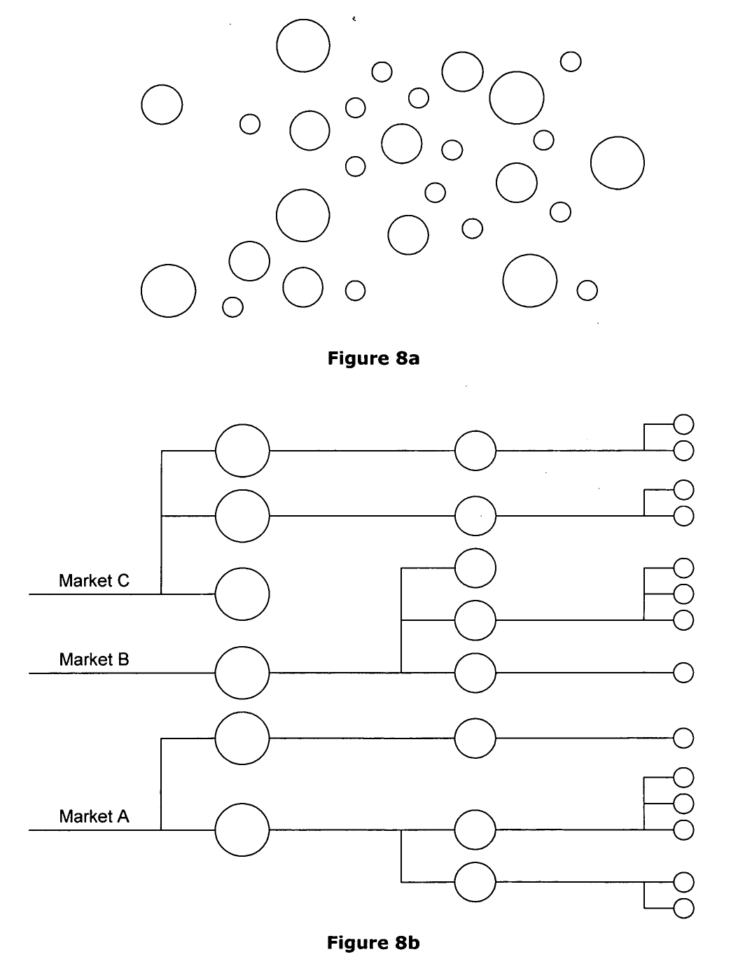

FIG. 8a and 8b are a graphical representation comparing the typical sponsorship program designed for sponsors currently and the sponsorship program designed as a family of events using the disclosed system. In FIG. 8a is seen that historically, sponsors and their advertising agents choose events to sponsor randomly, without coordinating demographics, theme and activation timing. In FIG. 8b a diagram illustrates that specific markets have been chosen, and the events organized using demographic, geographic and thematic criteria into systems of interrelated events associated with the market to which they most appeal. In addition, they are organized according to the cost effectiveness of obtaining sponsorship rights, and, by the timing of activating the surrounding media system for each event. Usually each event is interrelated to the next and one event can build on another. The more layers of event sponsorship a given market has assigned to it, the deeper the impression depth obtained for that market.

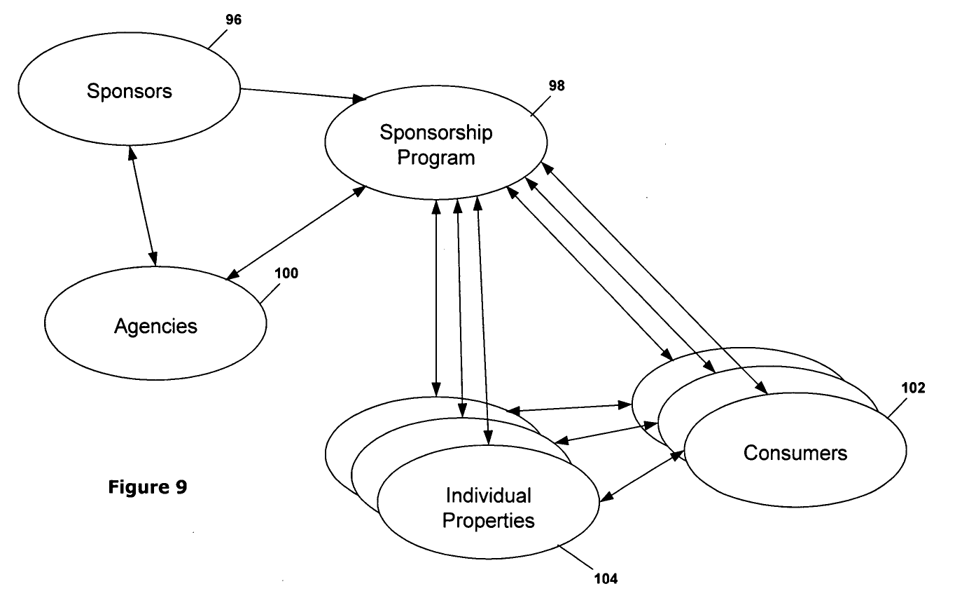

FIG. 9 is a diagram depicting the interaction of the disclosed system with various stakeholders and actors. Sponsorship programs 98 are created by associating events 104 into families of events or communities of events using input from sponsors 96 and their advertising agencies 100, the input concerning their consumer reach, geography, demographic and impression depth goals. Sponsorship programs 98 have a two way relationship with events 104. Sponsorship programs 98 increase event attendance and through the surrounding media increase the excitement and general goodwill within a community concerning the event. By providing fun and pageantry, events 104 enhance the sponsorship program and, through the program, other events in the family. By engaging consumers 102 directly, sponsorship program 98 contributes to their experience around events 104, and consumers contribute to the sponsorship program by being filmed at the event or chamber of commerce tour stop and by participating in contests. Consumers 102 are also interrelated to events 104 through their participation.

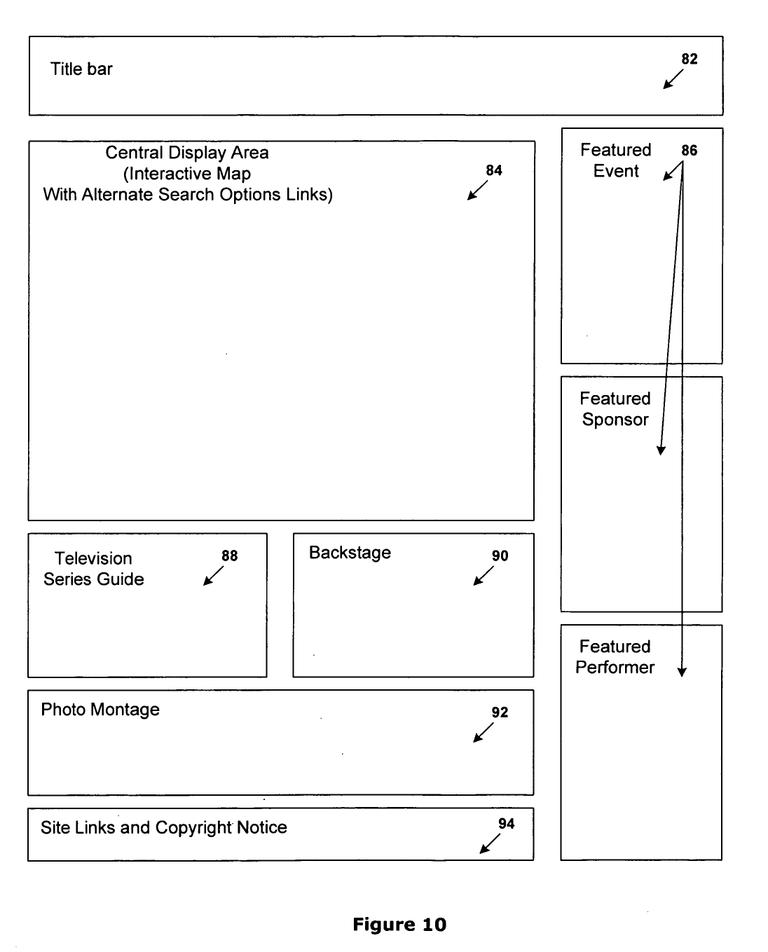

FIG. 10 is a schematic diagram for the initial webpage viewed by visitors to the Internet website. Each of the titled and numbered boxes indicates the area on a single webpage allocated a function of the webpage. Some areas are programmed for interactivity, while others are merely for display to the webpage visitor.

Title bar 82 contains the company logo of the company using the disclosed system, plus links to other principle pages on the website offering features such as various search functions, a photo gallery, browsing of performers, sponsors or vendors, browsing of events by categories and the “backstage” services discussed above. Additionally, links may be displayed for navigation to pages offering listing an event for free and sponsor services.

Central display area 84 is the main display area for the website. Most of the other numbered areas on the webpage remain displayed during a visit, with area 84 reloading to serve the functions requested by the visitor. On visitors arriving at the website, central display area 84 is displaying the interactive map, the geographic searching function using a drilling down technique described above. Website guests search for an event by clicking on the interactive world map to select a country, then clicking on that country's map to select a region, clicking on that region's map to select a city and so forth, each map displaying in area 84, until they have narrowed their search to the geographic area they desire. Then visitors select to see a list of all the events available for the area. Search results appear in the same webpage area 84 as a list. Visitors may then click on a specific event in the list and a detailed description of the event is displayed, also in area 84. Throughout this process, alternate search option links are displayed in area 84. At any time, a visitor may opt to search using an alternate method, such as searching by keyword, subject or typed-in location, by clicking on a link so labeled. Should a visitor opt to move to another page and search by an alternate method, they may return to the interactive map by clicking on a link back to the map function, the link provided on the subsequent pages in area 84.

Areas 86 are display areas for event related entities, such as performer, sponsor, product, vendor and the event itself. Displays are advantageously designed similarly to a poster with a title, graphic or photo and small amount of detail, such as dates. Each display in areas 86 has a link to a detailed description of the event related entity. When a visitor clicks this link, the detailed information is displayed in area 84. Optimally, display areas 86 refresh with new entities at regular intervals during a visit, such as whenever the visit requires the reloading of the page. For example, should a visitor request an alternate search method, such as a keyword search, area 84 reloads to display input boxes for the keyword search. At the same time, one of the areas 86 loads another featured performer. When the input boxes are displayed in area 84, the new performer is displayed in one of the areas 86.

Typically, areas 88 and 90 display upon the initial upload of the webpage and are displaced by an expanded central display area 84 after the visitor's first navigation request. Area 88 displays the advertisement for media presentation filmed at the events and broadcast at a later time, such as television programs. By visitors clicking on the links in this area, central display area 84 displays further information such as information about broadcasts, upcoming filming and guest host auditions. Area 90 contains links to the “Backstage” services, such as finding infrastructure suppliers, merchants and concessionaires, performers. “Backstage” is also where promoters and sponsors access the services described in this application and most probably provided by the company creating the webpage.

Area 92 displays a photo montage communicating the fun, excitement and pageantry of community events.

Principle links to other pages on the website offering features such as various search functions, browsing of events by categories, display of information about the company, display of contact information and links for the company, privacy policy and terms of use are continuously displayed at the bottom of the page in area 94, along with copyright notice for the webpage.

With regard to systems and components above referred to, but not otherwise specified or described in detail herein, the workings and specifications of such systems and components and the manner in which they may be made or assembled or used, both cooperatively with each other and with the other elements of the invention described herein to effect the purposes herein disclosed, are all believed to be well within the knowledge of those skilled in the art. No concerted attempt to repeat here what is generally known to the artisan has therefore been made.

### INDUSTRIAL APPLICABILITY

The disclosed system provides a desirable and highly effective means for event sponsors and event promoters to interact and surround an event with integrated media when compared with systems currently used by sponsors and promoters. Through the expansion of marketing elements, the innovative usage of traditional elements and the interaction and integration of all elements, event attendees and customers are funneled into lasting relationships with the event and its sponsors. The effective reach of the celebration of the event is positively associated with sponsors and extended before and after the actual dates of the event.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

I claim:

1. A system comprising an event community of one or more events where at least one event promoter and at least one event sponsor are linked to one another and to at least one event in mass media advertising.

2. The system of claim 1 wherein the system further comprises:
at least one computer hosting an event Internet site, operatively connected to a distributed network;
the event Internet site further operatively connected to at least one information source of event content, the at least one information source of event content residing on computer readable media;
at least one input device through which a user accesses the event Internet site and inputs data;
at least one output device through which a user accesses the event Internet site and receives selected output;
an application running on the event Internet site, wherein the application is adapted to receive search criteria input from a user, return search results of event information, receive event content from a user and display advertising to a user based on user input;
a subsystem for providing at least one contest to at least one contest participant, the subsystem comprising:
at least one input device through which a user inputs contest data;
at least one output device through which a user receives selected contest output;
an application running on at least one computer having computer readable media, wherein the application is adapted to perform one or more process steps selected from the group of process steps consisting of receiving contest data input from a user, returning advertising to a user based on user input, storing contest data on computer readable media, selecting a contest winner from stored contest data, and generating electronic messaging using contest data;
a media presentation composed during each event of participation in each event and distributed after each event;
a chamber of commerce tour, comprising one or more tour stops with media or live presentation delivered to an audience according to a presentation schedule at geographically related sites with audience participation selected from the group of audience participation consisting of chanting, filming of a media presentation composed during each tour stop and such media presentation being presented at succeeding tour stops, entering a contest, filming of election candidates, voting in an election, discussion of events and sponsors and distribution of promotional codes.

3. The system of claim 1 wherein the system further comprises:
at least one computer hosting an event Internet site, operatively connected to a distributed network;
the event Internet site further operatively connected to at least one information source of event content, the at least one information source of event content residing on computer readable media;
at least one input device through which a user accesses the event Internet site and inputs data;
at least one output device through which a user accesses the event Internet site and receives selected output;
an application running on the event Internet site, wherein the application is adapted to receive search criteria input from a user, return search results of event information, receive event content from a user and display advertising to a user based on user input.

4. The system of claim 1 wherein the system further comprises:
at least one computer hosting an event Internet site, operatively connected to a distributed network;
the event Internet site further operatively connected to at least one information source of event content, the at least one information source of event content residing on computer readable media;
at least one input device through which a user accesses the event Internet site and inputs data;
at least one output device through which a user accesses the event Internet site and receives selected output;
an application running on the event Internet site, wherein the application is adapted to receive search criteria input from a user, return search results of event information, receive event content from a user and display advertising to a user based on user input;
a media presentation composed during each event of participation in each event and distributed after each event.

5. The system of claim 1 wherein the mass media advertising occurs before, during or after the event, in combination or singly.

6. An event community where an event and its sponsors are linked and promoted on a website for the event, the website comprising:
at least one computer hosting an event Internet site, operatively connected to a distributed network;
the event Internet site further operatively connected to at least one information source of event content, the at least one information source of event content residing on computer readable media;
at least one input device through which a user accesses the event Internet site and inputs data;
at least one output device through which a user accesses the event Internet site and receives selected output;
an application running on the event Internet site, wherein the application is adapted to receive search criteria input from a user, return search results of event information, receive event content from a user and display advertising to a user based on user input.

7. The system of claim 6 wherein the system further comprises one or more of the following system:
a subsystem for providing at least one contest to at least one contest participant, the subsystem comprising:
at least one input device through which a user inputs contest data;
at least one output device through which a user receives selected contest output;
an application running on at least one computer having computer readable media, wherein the application is adapted to perform one or more process steps selected from the group of process steps consisting of receiving contest data input from a user, returning advertising to a user based on user input, storing contest data on computer readable media, selecting a contest winner from stored contest data, and generating electronic messaging using contest data;
a media presentation composed during each event of participation in each event and distributed after each event;
a chamber of commerce tour, comprising one or more tour stops with media or live presentation delivered to an audience according to a presentation schedule at geographically related sites with audience participation selected from the group of audience participation consisting of chanting, filming of a media presentation composed during each tour stop and such media presentation being presented at succeeding tour stops, entering a contest, filming of election candidates, voting in an election, discussion of events and sponsors and distribution of promotional codes.

8. The system of claim 6 wherein the system further comprises:
a subsystem for providing at least one contest to at least one contest participant, the subsystem comprising:
at least one input device through which a user inputs contest data;
at least one output device through which a user receives selected contest output;
an application running on at least one computer having computer readable media, wherein the application is adapted to perform one or more process steps selected from the group of process steps consisting of receiving contest data input from a user, returning advertising to a user based on user input, storing contest data on computer readable media, selecting a contest winner from stored contest data, and generating electronic messaging using contest data.

9. The system of claim 6 wherein the system further comprises a media presentation composed during each event of participation in each event and distributed after each event.

10. The system of claim 6 wherein the mass media advertising occurs before, during or after the event, in combination or singly.

11. An event community where an event and its sponsors are linked and promoted through a media presentation occurring after the close of each individual event.

12. The system of claim 11 wherein the system further comprises one or more of the following system:
a subsystem for providing at least one contest to at least one contest participant, the subsystem comprising:
at least one input device through which a user inputs contest data;
at least one output device through which a user receives selected contest output;
an application running on at least one computer having computer readable media, wherein the application is adapted to perform one or more process steps selected from the group of process steps consisting of receiving contest data input from a user, returning advertising to a user based on user input, storing contest data on computer readable media, selecting a contest winner from stored contest data, and generating electronic messaging using contest data;
at least one computer hosting an event Internet site, operatively connected to a distributed network;
the event Internet site further operatively connected to at least one information source of event content, the at least one information source of event content residing on computer readable media;
at least one input device through which a user accesses the event Internet site and inputs data;
at least one output device through which a user accesses the event Internet site and receives selected output;
an application running on the event Internet site, wherein the application is adapted to receive search criteria input from a user, return search results of event information, receive event content from a user and display advertising to a user based on user input;
a chamber of commerce tour, comprising one or more tour stops with media or live presentation delivered to an audience according to a presentation schedule at geographically related sites with audience participation selected from the group of audience participation consisting of chanting, filming of a media presentation composed during each tour stop and such media presentation being presented at succeeding tour stops, entering a contest, filming of election candidates, voting in an election, discussion of events and sponsors and distribution of promotional codes.

13. The system of claim 11 wherein the system further comprises:
at least one computer hosting an event Internet site, operatively connected to a distributed network;
the event Internet site further operatively connected to at least one information source of event content, the at least one information source of event content residing on computer readable media;
at least one input device through which a user accesses the event Internet site and inputs data;
at least one output device through which a user accesses the event Internet site and receives selected output;
an application running on the event Internet site, wherein the application is adapted to receive search criteria input from a user, return search results of event information, receive event content from a user and display advertising to a user based on user input.

14. The system of claim 11 wherein the system further comprises:
a chamber of commerce tour, comprising one or more tour stops with media or live presentation delivered to an audience according to a presentation schedule at geographically related sites with audience participation selected from the group of audience participation consisting of chanting, filming of a media presentation composed during each tour stop and such media presentation being presented at succeeding tour stops, entering a contest, filming of election candidates, voting in an election, discussion of events and sponsors and distribution of promotional codes.

15. The system of claim 11 wherein the mass media advertising occurs before, during or after the event, in combination or singly.

16. A system comprising an event community of one or more events where at least one event promoter and at least one event sponsor are linked to one another and to at least one event in mass media advertising, and the system further comprises:
at least one computer hosting an event Internet site, operatively connected to a distributed network;
the event Internet site further operatively connected to at least one information source of event content, the at least one information source of event content residing on computer readable media;
at least one input device through which a user accesses the event Internet site and inputs data;
at least one output device through which a user accesses the event Internet site and receives selected output;
an application running on the event Internet site, wherein the application is adapted to receive search criteria input from a user, return search results of event information, receive event content from a user and display advertising to a user based on user input;
a subsystem for providing at least one contest to at least one contest participant, the subsystem comprising:
at least one input device through which a user inputs contest data;
at least one output device through which a user receives selected contest output;
an application running on at least one computer having computer readable media, wherein the application is adapted to perform one or more process steps selected from the group of process steps consisting of receiving contest data input from a user, returning advertising to a user based on user input, storing contest data on computer readable media, selecting a contest winner from stored contest data, and generating electronic messaging using contest data;
a media presentation composed during each event of participation in each event and distributed after each event;
a chamber of commerce tour, comprising one or more tour stops with media or live presentation delivered to an audience according to a presentation schedule at geographically related sites with audience participation selected from the group of audience participation consisting of chanting, filming of a media presentation composed during each tour stop and such media presentation being presented at succeeding tour stops, entering a contest, filming of election candidates, voting in an election, discussion of events and sponsors and distribution of promotional codes.
